(19) United States
(12) Patent Application Publication
(10) Pub. No.: US 2005/0281450 A1
(43) Pub. Date: Dec. 22, 2005

(54) System and method for correcting data in financial documents

(75) Inventor: Joseph L. Richardson, Germantown, TN (US)

Correspondence Address: STEPHEN M. PATTON, 7881 GROVE COURT EAST, GERMANTOWN, TN, 38138, US

(73) Assignee: DigiCor LLC

(21) Appl. No.: 11/156,685

(22) Filed: Jun. 20, 2005

Related U.S. Application Data
(60) Provisional application No. 60/580,855, filed on Jun. 18, 2004.

(51) Int. Cl. G06K 9/00

(52) U.S. Cl. 382/139

(57) ABSTRACT

A system and method for correcting data in data fields of financial documents containing unreadable characters is described.

### CROSS REFERENCE TO RELATED APPLICATIONS

The application claims priority from provisional patent application U.S. Pat App. No. 60/580,855 filed Jun. 18, 2004 and entitled “System and Method for Correcting Data in Financial Documents” which is incorporated herein by reference for all that it teaches.

### FIELD OF THE INVENTION

This invention relates generally to the field of document processing in the financial industry and more particularly to a method and apparatus for the correction of data fields on financial documents.

### BACKGROUND OF THE INVENTION

Within the financial industry, hundreds of millions of checks and other financial documents such as bills, deposit slips, or invoices (collectively called “checks” herein) are created and processed daily. Document processing systems include document processors for physically handling and retrieving data from checks and data processors for analyzing and storing the retrieved data. The document processors' capabilities range from the very fast—processing up to 2400 documents per minute, to the very slow—processing 20 or fewer documents per minute. The high speed document processors are typically found in large data processing centers for financial institutions, while the slow speed processors are found closer to the physical location of the documents' entry into the document processing system, such as a local branch office of a bank. The document processors typically include a controller, a MICR data reader, and optionally a scanner or other optical apparatus, such as a digital camera, that is operable to create and transmit an image of each document as it is processed. The image may be a scanned image or picture of the entire document, or a portion thereof.

To move checks and other documents through the document processor, a typical document processor includes a high speed transport mechanism, typically arranged as a conveyor with rollers, belts, or other devices for transporting a stream of checks from an input hopper (or bin) of the document processor to one or more output hoppers (or bins) of the document processor. These transport mechanisms are responsible for moving the checks in front of the scanner and also the MICR reader.

The MICR reader itself includes one or more magnetic heads that are configured to sense the presence or absence of magnetic ink on the check. As the transport mechanism moves the stream of checks across the MICR reader, the magnetic heads sense the characters printed in magnetic ink much as the tape head in a tape recorder senses the magnetic patterns stored on the magnetic tape.

The MICR reader senses data printed on checks in a specially formulated magnetic ink along the bottom edge of the check. This data is printed in a special font called the E13B font, which was devised to be recognizable both by sight, and by electronic scanning using a MICR reader. One can see characters printed in this font with magnetic ink along the bottom of every preprinted bank check. This font must meet the ANSI X9.27 standard, which is incorporated herein by reference for all that it teaches.

The document processors are not perfect machines. Unfortunately, many checks are scored, torn, stapled, bent, or otherwise mishandled during their lifetimes before they are deposited at the bank. This treatment often causes the characters printed on the checks to fray, crumple, become obscured, or otherwise become unreadable. The percentage of checks that are unreadable is not large, however. Only about 1% of all checks processed each day have one or more characters that are unreadable by the MICR reader. Since millions of checks are processed each day, however, this means that hundreds of thousands of checks each day have one or more MICR characters that are unreadable by the MICR reader when they are scanned.

Each of these checks, until now, required special processing as an exception outside of the usual data flow path. This special processing is generally called “reject processing” or “reject handling”. It adds considerably to the cost of processing each check. The cost of processing a check that is readable in a MICR reader is typically around 2-3 cents per check. If the check is not readable, and must be taken out of the standard data and paper flow path and handled especially as an exception to the standard process it costs more, typically 10-20 cents per check.

One method of such reject processing includes presenting an electronic image of the check (or the portion thereof having unreadable characters) to a digital computer programmed with image recognition software. The image recognition software is configured to analyze the electronic image and electronically determine what the characters that were unreadable by the MICR reader actually are. If the image recognition software can recognize the unreadable characters, the computer is configured to transmit the recognized character back to the computer program on the same or different computer that requested the recognition to be performed. This method is less than satisfactory, however, and typically recognizes only 65% to 90% of the unreadable characters. This process is also known as “reco” or character recognition.

In an alternative or supplemental method of reject processing, a digital computer workstation is programmed to present the electronic image of the check (or the portion thereof having unreadable characters) on its computer terminal to the terminal operator. The operator then recognizes the unreadable character or characters and enters those characters, typically by a computer keyboard, into the computer workstation. The computer workstation, in turn, transmits the recognized characters back to the computer program on the same or different computer that requested the recognition to be performed.

In another alternative or supplemental method of reject processing, unreadable checks are routed into special hoppers or bin portions of the document processor commonly called “pockets” and are subsequently carried to an operator located at a digital computer workstation. The operator of the computer workstation looks at the check to determine what the actual characters are. If the operator can recognize the characters that were unreadable by the MICR reader, the operator types the correct characters into the computer workstation and the computer workstation then reintegrates the check's data into the standard data stream. The computer workstation is configured to receive data identifying the check, such as the bank routing number, account number, check number, and amount, and to permit the operator to correct any characters that were unreadable. This system is accurate, more accurate than machine recognition, however it does require that checks with unreadable characters be separated from the other checks with readable characters and transported to a separate location for viewing and processing by the operator. Whenever checks are separated into two separate process flow paths, there is a risk that they will not be reintegrated properly, and may become lost or mislaid.

In another alternative or supplemental method of reject processing, the checks with unreadable characters are placed back into the input hopper of the document processor and are run through the same or different document processor again. Many characters can be recognized during the second pass through the document processor.

In another alternative method of reject processing, computer workstations are programmed to display an image at least of the unreadable portion of the check, presenting the workstation operator with the incomplete string of characters (i.e. the incomplete bank routing number) and permitting the operator to visually recognize the unreadable characters in the image of the check, and to manually type in the correct characters that were unreadable by the MICR reader into the computer Workstation using an operator input device such as a keyboard, mouse, or voice-recognition system. These systems have the advantage of permitting the document processor-scanned checks to be kept together.

In another alternative or supplemental method of exception processing during a second pass of the check through the document processor, if the second pass reading of the check has unreadable characters, and the first pass reading of the check read all the characters (or all the characters of interest, such as old characters comprising the account number, or, more preferably, the bank routing number), then the characters read during the first pass reading of the check are used. This process is called “code line data matching”.

U.S. Pat. No. 6,608,274 B1 makes improvements upon the code line data match process. The code line data match process and enhancements described in the related patent have several disadvantages. Code line data match is susceptible to out-of-sync conditions that occur when the order of the physical documents on the second capture differs from the order of presentment on the first capture. Code line data matching depends on the document's data fields being previously captured and therefore can not be utilized on the initial capture pass for the document. Although U.S. Pat. No. 6,608,274 B1 increases the size of the code line data match buffer up to 20,000 documents, there is no guarantee a document can be located in the buffer at all or located in the time available for processing.

These various methods of reject processing can also be used sequentially and supplementally to recognize an unreadable check. In other words, a second pass of the check through the document processor can be performed to see whether that cures the error. If that doesn't correct all the errors, an image of the check can be presented to the computer programmed with image recognition software. If that doesn't correct all the errors, the electronic image can be presented to the human operator. If that doesn't correct all the errors, the paper check itself can be presented to the human operator. Any one or more of these methods of reject processing can be used. These methods of reject processing are merely examples of a wide array of reject processing techniques used in the financial document processing industry.

Many attempts have been made to decrease the document reject rate (improve the read rate) of MICR readers in document processors. These attempts include hardware and software modifications to the controllers coupled to (or a part of) the document processor; standardization of the document, including the data layout, fonts utilized, and the weight and type of paper utilized. These standards include the ANSI X9B standard for check printing (which is incorporated herein for all that it teaches) used to produce checks that are more readable and less prone to damage—and the ANSI X9.90 standard (which is incorporated herein for all that it teaches) for printing of image replacement documents used to manufacture replacement checks.

One reason the MICR reader provides such poor results is because of the extreme requirements placed on it. The MICR reader must determine which character of 15 characters, the digits (0-9), a space, and four special symbols (including a dash symbol) is located at each character position on the check. This process has been made somewhat easier for the MICR reader by ANSI standards that mandate very distinct and unique shapes for each of the 10 digits and four symbols. A cursory examination of any preprinted check will show that each digit has a very unique shape that is very different from the other digits—or at least as different as possible while still permitting the human eye to distinguish the 10 digits as well. Even with these distinctive shapes, however, the MICR reader must distinguish between 15 different characters at each character location.

Similarly one reason the character recognition reject process also provides such poor results is because it, too, must identify which one of a universe of 15 different characters is found at each character location. This is troublesome for checks, because many checks have colorful backgrounds or other printing on them that can confuse the image recognition software. For example, when checks are signed, portions of the signature will descend into and obscure portions of the MICR data on the check. If the pen doing the writing happens to be black, image recognition software will become confused, and no longer be able to tell where one MICR character quits and another one begins. Again, with fifteen possible characters to be recognized at each location even small smudges, lines, jots, or tittles, can confuse the image recognition software.

What is needed, therefore, is a computer implemented system and method for automated processing of checks that reduces the MICR read errors that normally occur in the processing of checks. What is also needed is a computer implemented system and method for automated processing of checks that does not require checks or data to be removed from the data stream and processed separately. What is also needed is a computer implemented system and method for automated processing of checks that can be implemented by minor modifications or enhancements to existing equipment. What is also needed is a computer implemented system and method for processing checks that can correct recognition errors in the existing system without taking the paper checks out of currently existing paper streams in a check processing facility. What is also needed is a computer implemented system and method for processing checks that can correct recognition errors without removing individual electronic check records from the existing data streams. These and other advantages are provided by the invention described below in one or more embodiments.

### SUMMARY OF THE INVENTION

In accordance with one aspect of the invention a computer-implemented system for correcting MICR data fields on financial documents is provided, comprising: a controller configured to receive MICR data from a document processor that is operable to retrieve MICR data from a plurality of financial documents; wherein the controller is programmed to perform data correction functions on the MICR data, the data correction functions further comprising comparing an erroneous number in said MICR data with a plurality of correct numbers and electronically replacing the erroneous number with a number from said plurality of possible numbers.

The MICR data may include a bank routing number, and further wherein the erroneous number is a bank routing number, and further wherein the plurality of possible numbers include a list of valid bank routing numbers. The erroneous number may have a first plurality of known correct characters and at least one known incorrect character. The controller may be configured to determine all correct numbers from the plurality of numbers that have the first plurality of correct characters. The controller may be configured to replace all incorrect characters of the erroneous number with corresponding characters of the only one number when there is only one number of the determined correct number that was determined to be correct. The controller may be configured to replace a first character of said at least one known incorrect character in a first character position with a replacement character if all of the correct numbers have said replacement character in respective first character positions of all of said correct numbers. The controller may be configured to correct the erroneous number by replacing all incorrect characters in a RAM buffer of the controller. The controller may be operable to correct erroneous numbers from at least two MICR data fields on each of the plurality of financial documents by comparing an erroneous number in said MICR data in each of the at least two MICR data fields with a plurality of possible numbers for each of the at least two MICR data fields and by electronically replacing the erroneous number with a number from said plurality of possible numbers. The system may further comprise the document processor.

In accordance with a second aspect of the invention, a computer-implemented method for correcting MICR data on financial documents is provided, comprising the steps of: electronically comparing an erroneous number in said MICR data with a plurality of possible numbers and electronically replacing the erroneous number with a number electronically selected from said plurality of possible numbers.

The step of electronically comparing may include the step of electronically comparing an erroneous bank routing number in said MICR data with a list of valid bank routing numbers and electronically replacing the erroneous bank routing number with a bank routing number from said list of valid bank routing numbers. The erroneous number may comprise a first plurality of known correct characters and at least one unrecognized character. The method may further comprise the step of determining all correct numbers from the plurality of possible numbers that have the first plurality of known correct characters. The method may further comprise the step of replacing all incorrect characters of the erroneous number with corresponding characters of the only one number when there is only one number of the determined correct number that was determined to be correct. The method may further comprise the step of replacing a first character of said at least one known incorrect character in a first character position with a replacement character if all of the correct numbers have said replacement character in respective first character positions of all of said correct numbers. The method may further comprise the step of replacing the erroneous number with the only one number that was determined to be correct in a RAM buffer of the controller. The step of electronically comparing may comprise the steps of: electronically comparing a first erroneous number in a first MICR data field with a first plurality of all possible numbers that the first erroneous number can be and still be valid; and electronically replacing the first erroneous number with a number selected from the first plurality based at least upon the outcome of the step of electronically comparing.

In accordance with another aspect of the invention, a computer-implemented method for correcting a line of MICR data of a financial document having an unreadable character is provided, comprising the steps of: electronically scanning the line of MICR data using a MICR reader; converting the line of MICR data into a first series of numbers and storing the first series in an input buffer; identifying a first MICR field from the first series of numbers; sequentially comparing a readable portion of the first MICR field with each successive member of a list of valid first field numbers to determine whether a unique member of the list of valid first field numbers matches the readable portion; and replacing the first MICR field with the unique member or with portions of the unique member that correspond to an unreadable portion of the first field.

The step of replacing the first MICR field may comprise the step of replacing the first MICR field in the input buffer with the unique member or with portions of the unique member that correspond to an unreadable portion of the first field. The method may include the step of leaving at least one unreadable portion of the line of MICR data unchanged.

In accordance with one aspect of the present invention, a method and system for correcting data fields containing unknown characters are provided that substantially eliminate or reduce disadvantages and problems associated with previously developed systems and methods.

In accordance with one aspect of the present invention, a system for correcting MICR data fields on checks, money orders, or other financial documents is provided that includes a document processor operable to retrieve MICR data from a plurality of financial documents and a document processor controller operable to receive MICR data from other systems.

The document processor incorporates a MICR reader that retrieves the MICR data from a document. A controller is coupled to the document processor. The controller is operable to store the MICR data containing routing numbers in a location in RAM defined as an input buffer. The controller is operable to store the input buffer in a location in RAM defined as a process buffer. The controller is operable to access, verify, and parse the MICR data in separate data fields. The controller is operable to examine the MICR data in the input buffer and retrieve the routing number. The controller is configured to perform data correction functions. The data correction functions search a list of all valid routing numbers, returning a plurality of valid routing numbers where each valid digit in the routing number equals the digit in the corresponding positions of the valid routing numbers. If a single valid routing number is returned from the search, the data correction functions replace the routing number in the input buffer with the valid routing number retrieved from the list.

Alternatively, and in addition to, the controller may be configured to correct the account number field in the input buffer, by searching a list a valid account numbers, and replacing the account number in the input buffer with a valid account number from the list.

Alternatively, and in addition to, the controller may be configured to correct other data fields in the input buffer, by searching a list of valid values, and replacing the data field in the input buffer with the valid value.

Alternatively, the controller need not be coupled to a document processor. The MICR data may be received by the controller from systems other than a document processor.

Alternatively, the controller may be configured to execute software programs that emulate the functions performed by the controller coupled with IBM 3890/XP series document processor. These software programs include the “3890/XP Emulation” product by OmniSoft, Inc., the NexGen Capture product from Carreker Corp., and other emulator products from Software Earnings, Inc., and Sterling Software.

Alternatively, the logic comprising the data correction function may be encoded in hardware, firmware, and/or software instructions stored in RAM, ROM, and/or other suitable computer-readable media.

An important technical advantage of the present invention is an improved recognition rate for the document processors, resulting in fewer documents requiring correction via a character recognition function and a data entry reject correction process. Another technical advantage is that the present invention corrects the data in the input buffer prior to any other function examining or retrieving data from the input buffer, so that the use of the present invention is transparent to all other functions. With the present invention, the data in the input buffer appears as if the MICR reader initially read the data correctly.

The present invention differs from the code line data match process and enhancements described in the related patent in that no prior read of the document's data fields is required. Another technical advantage is the present invention is not susceptible to out-of-sync conditions as can occur with code line data matching when the order of the physical documents on the second capture process on the document processor differs from the order the documents were processed on their first capture process on the document processor.

Code line data matching compares the data in an entire MICR line of a just-scanned check with similar entire MICR line taken from a previous scan of the identical document.

Unlike code line data matching, data fields may be corrected using the process described herein independent of document order or prior data retrievals from the document.

In accordance with another aspect of the present invention, a method and system is provided for improving the character recognition rate of the routing number field visible on an image of a check. The system includes an image controller configured to transmit a check image over a communications link to a recognition controller configured to perform character recognition functions. A program stored in RAM configures the recognition controller to perform data correction functions.

The recognition controller performs the character recognition function to determine the value of the check's routing number by examining the check's image. If there are any undetermined (unreadable) characters in the routing number, the recognition controller performs the data correction function. The data correction function incorporates logic that receives the routing number that may contain a plurality of undetermined characters, and provides the character recognition function a reduced set of valid possible values for the routing number. The data correction function does not require the document image to perform its function.

The data correction function incorporates logic that searches a list of all valid, assigned, and active routing numbers, returning a set containing a plurality of valid routing numbers where each known digit in the document's routing number equals the digit in the corresponding position of each valid routing number in the set. On the majority of documents where a plurality of digits within the routing number is undetermined, fewer than four of the required nine digits within the routing number were undetermined. The data correction function incorporates logic that typically provides a set of five or fewer matching valid routing numbers when fewer than four digits are undetermined. The character recognition function comprises logic that utilizes this small set of five routing numbers out of the possible 1 billion routing numbers to improve its success in determining the true routing number present on the document image.

Alternatively, the recognition controller may be configured to iteratively perform the character recognition function and data correction function on the same document image. The present invention provides technical advantages by improving the success rate of the character recognition function by modifying the set of valid matching routing numbers on each of a plurality of iterative attempts by the character recognition function to determine the value of the routing number.

Alternatively, the check may be other types of documents, including money orders, or other financial documents.

Alternatively, and in addition to, the recognition controller may be configured to perform the data correction function on the account number field of the document. The data correction function incorporates logic that searches a list of valid account numbers, and returns the list of valid account numbers to the character recognition function. The account number list can contain all account numbers issued by an institution or a subset of the account numbers issued by the institution, such as those accounts required by ‘cycle sort’ and ‘statement sort’ work types processed on document processors. A plurality of account lists from a plurality of institutions may be loaded and searched by the controller during the data correction function.

Alternatively, and in addition to, the recognition controller may be configured to perform the data correction function on other fields on the document. The data correction function comprises logic that searches a list a valid values for the field, and returns a set of valid values to the character recognition function.

Alternatively, the data correction function is performed by a data correction controller. The data is transmitted across a public or private communication link between the data correction controller and the recognition controller.

Alternatively, the logic incorporated into the data correction function may be encoded in hardware, firmware, and/or software instructions stored in RAM, ROM, and/or other suitable computer-readable media.

A technical advantage of the present invention is an improvement in the character recognition rate when determining the value of data present on a document image.

Other technical advantages will be readily apparent to one skilled in the art from the included figures, description, and claims.

In accordance with another aspect of the present invention, a method and system is provided to receive data comprised of a routing number and other information, and transmitting a list of matching valid routing numbers and other information to a financial institution. The system includes a controller configured to receive the routing number, perform data correction functions, and transmit the matching valid routing number or numbers to a financial institution.

Alternatively, the data correction function is performed by a data correction controller or a plurality of data correction controllers. The data is transmitted across a public or private communication link between one of plurality of data correction controllers and one of a plurality of recognition controllers located in different geographic locations and operated by the same or different institutions. For example, the data correction function may be implemented as a web service on the internet available to multiple institutions simultaneously.

Alternatively, the controller may receive the data via a public or private communications link, or other input device attached to the controller, such as a keyboard, or mouse.

Alternatively, the controller may transmit the list of matching routing numbers over a public or private communications link, or make the list of routing numbers known to a human via a visual, audio, or other output device coupled to the controller.

Alternatively, the controller may be configured to compute a set of possible values for a character position within the routing number. The set of possible values are derived from the list of matching routing numbers provided by the data correction function.

Alternatively, the controller may transmit the set of possible values for a character position over a public or private communications link, or make this set known to a human via a visual, audio, or other output device coupled to the controller.

Alternatively, the data may be comprised of an account number and other information.

Alternatively, the data may be comprised of other information.

### BRIEF DESCRIPTION OF THE DRAWINGS

For a more complete understanding of the present invention and its advantages, reference is now made to the following description taken in conjunction with the accompanying drawings, wherein like numerals represent like parts.

FIG. 1 is a block diagram illustrating a system for processing documents that comprises a document processor in accordance with the first aspect of the present invention.

FIG. 2 is an illustration of a typical financial document shown in FIG. 1.

FIG. 3 is a flow diagram illustrating a process of configuring the check processing system of FIG. 1 to perform check processing.

FIG. 4 is a flow diagram illustrating operation of the system of FIG. 1, as configured by the process of FIG. 3, to process checks.

FIG. 5 is a flow diagram illustrating a method for correcting routing numbers in accordance with the second embodiment of the present invention illustrated in FIG. 7.

FIG. 6 is an alternative flow diagram illustrating a method for correcting routing numbers in accordance with the second embodiment of the present invention illustrated in FIG. 7.

FIG. 7 is a block diagram illustrating a system for correcting routing numbers in accordance with the second aspect of the present invention.

FIG. 8 is a block diagram illustrating a system for correcting routing numbers in accordance with the third aspect of the present invention.

FIG. 9 is a block diagram illustrating a system for correcting routing numbers in accordance with the third aspect of the present invention.

FIG. 10 is a block diagram illustrating a visual interface for correcting routing numbers in accordance with the third aspect of the present invention.

### DETAILED DESCRIPTION OF THE PREFERRED EMBODIMENTS

The term “check”, as that term is used herein, shall refer to any financial document with characters (letters, numbers, and punctuation) that are electronically read or scanned, recognized and converted to electronic data.

Theory

Checks, money orders, and other financial documents designed for automated handling and processing conform to one or more sets of standards. Among other things, these sets define the formats of the various characters inscribed on the documents, including their size, shape, and the inks with which they are printed, for example.

Checks have several data fields inscribed along their bottom edge that are defined by the standards. In particular, the ANSI X9B standard (ANSI, Washington, DC) defines the location of (among others) the bank routing number, the account number, and the amount of the check (which can be preprinted for security).

The routing number is a nine digit number assigned to qualifying financial institutions such as banks, savings and loans, and credit unions. The routing number identifies that institution for legal purposes. Each of the nine digit positions within the routing number is defined by standards of the American Banking Association to have any one of ten possible values: namely, the digits 0 through 9. With nine digits, each digit capable of having 10 values, the bank routing number is capable of representing up to 10⁹ or 1,000,000,000 (1 billion) possible routing numbers, and thus one billion different financial institutions.

While the theoretical number of financial institutions it can represent is one billion, the actual number is considerably less due to other requirements of the ABA standard, which mandate that routing numbers be represented only in specific digit combinations. In particular, routing numbers (which are assigned for the entire United States financial industry by TFP Corp. (NY, NY) are not assigned in consecutive order, but are assigned in a specific order an arrangement that makes it easy to determine whether a routing number is a valid routing number or whether it is forged.

According to the ABA standard, the digits of a routing number must be selected such that they pass a mathematical test called a “modulus check” or “modcheck” algorithm. To perform the “modcheck” algorithm for a bank routing number, one multiplies each digit of the bank routing number by a specific value. One then sums each of these products together. This summation is then divided by 10. If the remainder of this division is zero, the routing number passes the modcheck test.

The universe of nine digit numbers that can meet this modcheck routine is considerably less than one billion. Only about one million (1,000,000) of the one billion possible combinations of nine digits in the bank routing number field will meet the modcheck test. Thus only one million of these one billion possible numbers that can be expressed with the nine digits of the bank routing number field can be used as bank routing numbers. This works out to be only one out of every 1000 possible combinations of nine digits in the bank routing number field.

Of these one million possible numbers, only a tiny fraction has actually ever been assigned to a banking institution, however. Only about 65,000 unique bank routing numbers have ever been issued to qualified financial institutions. Furthermore, of the 65,000 assigned bank routing numbers, only one half are presently active and therefore valid to appear on checks. A bank routing number is “active” if it is assigned to a financial institution that is currently in business, is issuing checks with its routing number, and has accounts from which funds can be withdrawn using those checks. A bank routing number is inactive if the financial institution to which it was assigned is not in business, or has no checking accounts from which funds can be withdrawn using a check. Thus there are only about 26,000 valid bank routing numbers currently in use.

In order to meet the requirements of the modcheck test, these 26,000 valid bank routing numbers are not assigned in sequential order. There are numerical gaps between each bank routing number and its adjacent bank routing number. From a theoretical maximum of one billion numbers that can be expressed by the nine digits of the bank routing number field, only 26,000 are currently assigned and valid.

Furthermore, the 26,000 currently assigned and valid bank routing numbers are distributed throughout the entire nine digit range of one billion numbers. It is the fact that these numbers are distributed throughout this range that enables the correction process described herein.

To illustrate this correction process we will use a simplified example. Assume a valid routing number is only three digits long (000-999), thus providing for a theoretical maximum of 1000 possible bank routing numbers. Also assume that only 10% or so of these numbers are actually assigned to financial institutions. Assume that the algorithm (similar to the modcheck test, above) for assigning bank routing numbers requires that the routing number be evenly divisible by seven. In this example, therefore, only the numbers in the sequence 007, 014, 021, 028, 035, 042, 049, . . . , 091, 098, . . . , 140, 147, . . . , 196, . . . , 217, 224, 231, . . . , 735, 742, 749, . . . , 980, 987, 994 are possible valid bank routing numbers. There are 142 numbers in this range, only a few of which are shown above, the missing numbers being represented by ellipses.

Of this universe of possible valid bank routing numbers, in our example only 13 are assigned to financial institutions and active: 007, 035, 042, 091, 098, 140, 147, 196, 217, 224, 231, 735, and 987.

In the first example, consider that a check has been scanned by the MICR reader, which indicates that the routing number is 00*. In all the examples herein, the asterisk represents an unreadable character. In this case, by comparing this sensed number, 00*, with the list of 10 valid and assigned bank routing numbers and one can immediately determine what the actual bank routing number is: 007. Note that we could not determine the bank routing number just from the leading zero, because there are three different bank routing numbers that begin the zero. It required one additional number, the middle zero, to actually determine what the entire bank routing number (007) was. This is not always the case, however. Some bank routing numbers in the above example can be determined when only one digit of the bank routing number is known.

For example, consider that another check has been scanned by the MICR reader, which indicates the bank routing number is *3*. Again, the asterisks represent characters that the MICR reader was unable to read. In this example, by comparing this sensed number, *3*, (actually by comparing the single known digit—the middle digit) with the list of 10 valid and assigned bank routing numbers we can immediately determine that the actual bank routing number is 035. No other valid and assigned bank routing number has a second or middle digit that is the number “3”.

As another example, consider that the MICR reader scans another check and determines that the number is 14*. In this case, the error checking method using a list of valid and assigned bank routing numbers is of no use in determining the missing digit. This is true because there are two valid and assigned bank routing numbers—140, 147—that have a first digit “1” and second digit “4”. In this case, this error checking method fails and one of the other methods, such as the computer character recognition exception process or the operator recognition exception processes, or the code line data matching exception process must be performed in order to determine the full bank routing number.

As a final example, consider that the MICR reader scans another check and determines that the bank routing number on the check is *9*. Again, the ellipses representing digits the MICR reader was unable to read. Comparing this number with the 13 valid and assigned bank routing numbers, we cannot determine which one of three bank routing numbers is on the check. All we know is that the number on the check may be any one of 091, 098, and 196. Even though we cannot determine from a middle digit of “9” what the bank routing number is, we can know from this fact that it is one of only three numbers: 091, 098, and 196.

Consider, how difficult the problem is for a computer configured to perform an image recognition process to determine the bank routing number when only a single digit is readable. Assume an image of the check in the first example, above, is provided to an image recognition computer (i.e. the computer that is controlled by an image recognition program that is configured to determine the bank routing numbers), for analysis. Assume that the first and third digits of the bank routing number are unreadable because the ink has been scratched off or otherwise mutilated.

In this case, the image recognition computer could easily recognize the middle digit using standard image recognition algorithms. It could recognize the middle digit with a high degree of accuracy. The first and third digits, however, would be difficult for the image recognition computer to analyze, since the ink was scratched off and thus the characters were not easily readable. Without knowledge of the limited set of 13 valid and assigned bank routing numbers, the image recognition computer would be forced to compare the image of the first digit with its internal images of each the characters comprising the set of allowable characters (the set of 15 MICR characters).

With 15 possible characters to compare, the image recognition computer often cannot find enough similarity to any one digit to determine what the missing digit really is. On the other hand, if the image recognition computer were provided with the reduced set of possible characters between which to pick, even if the reduction is from the 15 possible MICR characters to ten digits, it can much more easily determine what the real missing digit is.

For example, if the image recognition computer were provided not only with an image of the check but with the three numbers 091, 098, and 196 from the previous example, it would know from the outset of its image analysis that the first digit has to be either a “0” or a “1”. Given these two choices, even if the first digit was seriously disfigured, the image recognition computer using any standard image recognition algorithm would be able to detect the proper digit much more often. In our example above, in which the MICR reader determined that the routing number is *9*, assume the image recognition computer accurately selects between the “0”, and the “1” and determines correctly that the first digit is “0”. In this case, the image recognition computer would know bank routing number is 09*, and only the remaining digit (represented by the asterisk) would be unknown. At this point, the image recognition computer could again compare the known digits against the universe of issued valid bank routing numbers and determine that there are only two choices for the last digit: “1” or “8”.

These last two digits being the last two digits of 091 and 098. The universe of possible bank routing numbers is reduced to only two numbers, since (having determined the first digit is an “0”) the image recognition computer knows that these are the only two remaining choices that could possibly match the first two digits, “09”.

Thus, the image recognition computer can iteratively determine the bank routing number by selecting a digit from a limited universe of digits derived from a list of valid and assigned bank routing numbers, then using that newly-selected digit to further reduce the universe of possible digits for one of the remaining missing digits in the bank routing number field, then performing its image analysis to determine that remaining missing digit (or digits).

Since there are nine digit positions that comprise the bank routing number, this process of iteration, first with one digit position, then using that information to reduce the number of choices, can be repeated up to eight times by the image recognition computer to determine what the actual bank routing number is.

The power of the technique of comparing a partial number against a list of valid numbers is quite significant, particularly when it is used for bank routing numbers. For example, an empirical analysis of all of the approximately 26,000 currently existing and valid bank routing numbers shows that there are 512 different patterns of erroneous bank routing numbers. Every possible combination of unreadable digits from one unreadable digit to all nine digits being unreadable adds up to 512. There are nine ways in which a single erroneous digit can appear in a bank routing number: the first digit could be in error, the second digit could be in error, the third digit could be in error, etc. There are 36 ways in which to erroneous digits could appear in a bank routing number: positions 1 and 2 in error, positions 1 and 3 in error, positions 1 and 4 in error, etc.

To determine how often the technique of comparing a partial bank routing number provided by the MICR reader with a list of actual valid bank routing numbers would be capable of finding the missing digits in the partial bank routing number we examined each of the approximately 26,000 valid bank routing numbers currently being used in United States.

For each of those 26,000 numbers, we repeatedly compared the number with between one and nine missing characters with the full list of bank routing numbers to see how many combinations of unreadable digits we could recover and determined the following.

Any single digit error in a bank routing number (i.e. a bank routing number having a single unreadable digit in any of the nine possible digit locations) can be corrected 100% of the time. In other words, as long as only a single digit is unreadable in the nine digit bank routing number, no matter what that bank routing number is, the system described herein will always be able to recover that one missing digit.

Any two digit error (i.e. a bank routing number having two unreadable digits in any two digit locations of the nine possible digit locations) can be corrected 83% of the time. In other words, 83% of all possible combinations of two unreadable digits in all of the 26,000 bank routing numbers can be recovered.

Any three digit error (i.e. a bank routing number having three unreadable digits in any three digit locations of the nine possible digit locations) can be corrected 51% of the time. In other words, 51% of all possible combinations of three unreadable digits in all of the 26,000 bank routing numbers can be recovered.

Any four digit error (i.e. a bank routing number having for unreadable digits in any for digit locations of the nine possible digit locations) can be corrected 17% of the time. In other words, 17% of all possible combinations of for unreadable digits in all the 26,000 bank routing numbers can be recovered. 17% can be corrected.

Furthermore, an analysis of the number of checks with routing number digit errors shows that approximately 88% of all checks with a routing number digit error have only a single digit in error. Approximately 8% of all checks with a routing number digit error have two digits in error. Approximately 3% of all checks with a routing number digit error have three digits in error. Less than 1% of all checks with a routing number digit error have four or more digits in error.

Combining these numbers, we have determined that one can correct the routing number on approximately 96% of all checks containing any number of digit errors (i.e. the MICR scanner is unable to read the number) in any combination within the routing number.

There is nothing unique or novel about bank routing numbers in and of themselves that make this error correction method particularly beneficial for bank routing numbers as opposed to the other MICR numbers written on checks. The power of this error correction method comes from the ability to compare a relatively short list, collection, or set of numbers or characters that are expressed using a number of characters that is significantly larger than the characters necessary to express the number of items in the list, collection or set. For example, the ABA standard defines the account number field as having up to 14 digits. It does not establish how the digits in the account number field shall be expressed. If a financial institution, for example, followed a similar formula in establishing account numbers as the formula followed in determining bank routing numbers, a similar large number of account numbers could be distributed throughout the usable range of the up to 14 account number digits. If the account numbers were so distributed, missing digits in the account number field could similarly be recovered using the same error correction technique. Likewise, the ABA standard defines four more fields, described below, that are similarly scanned by the MICR reader. These fields also benefit from the error correction technique described herein.

### Check Processing System with MICR Reader Error Correction

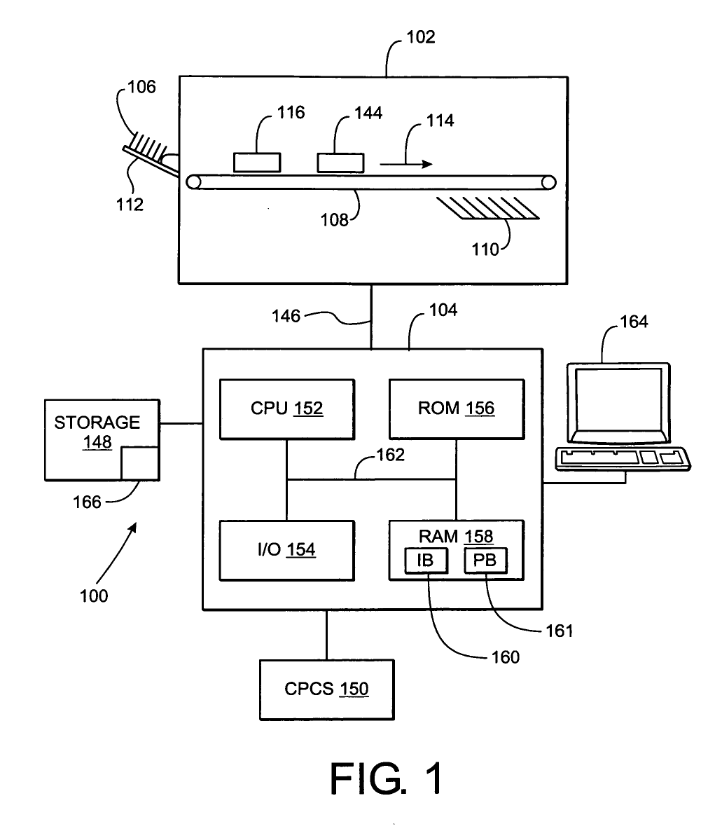

FIG. 1 is a block diagram of a check processing system 100 that includes a document processor 102 coupled to a controller 104 for processing checks. Document processor 102 is configured to receive a collection of checks 106. Processor 102 includes a transport mechanism 108 that sequentially moves each check in the collection of checks 106 through document processor 102 to output hoppers or “pockets” 110. The collection of checks 106 is first placed in an input hopper 112. Transport mechanism 108 is configured to engage each check in turn and to pull those checks, one after another, through check flow path 114, depositing them in pockets 110.

Document processor 102 also includes a MICR reader (also called a MICR scanner) 116 that is disposed along the flow path adjacent to the checks. MICR reader 116 is configured to sense the presence of each check as it travels past the scanner by magnetically coupling to characters printed on each check in magnetic ink. MICR reader 116 includes a magnetic sense head that generates an electrical signal as each character on each check passes by the sense head. These electrical signals are unique for each character in the MICR characters set. The MICR reader is configured to look at the unique signal coming from its sense head and from that signal to determine which character has passed across the sense head. The MICR reader includes analog circuitry coupled to a microcontroller (not shown) that interpret these electrical signals and convert them into a stream of numeric values, each numeric value representing a different character in the MICR characters set. The MICR reader is configured to transmit the stream of numeric values to controller 104 for further processing. The microcontroller in the MICR reader is also configured to substitute a numeric value into the data stream for each character it was unable to read. This numeric value is 15 (or 0×0F, in hexadecimal).

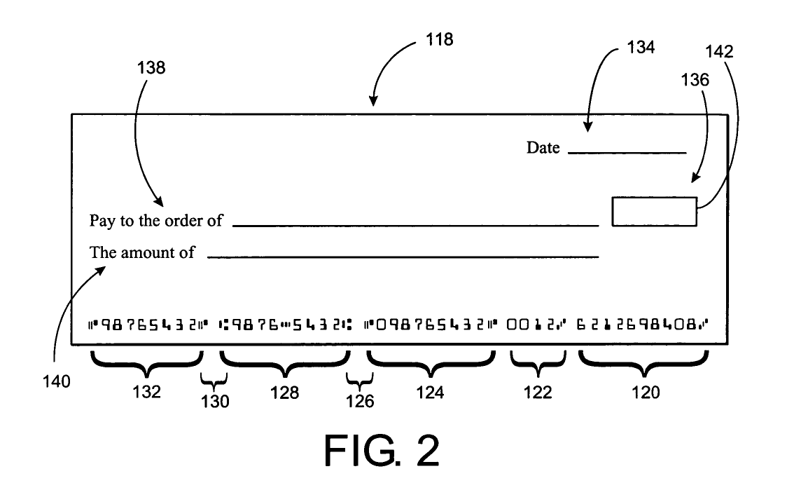

FIG. 2 illustrates a typical check 118, and shows the location of each of the characters printed in magnetic ink on the check. These characters are arranged in groups called “fields”. The fields are arranged in a single row extending across the bottom of the check. Not every check has every field. Several fields are optional. Starting at the right hand side, the fields are as follows.

An amount field 120 is used to indicate the amount of the check in electronic form. It is sometimes used by businesses to create a quantity of checks having a specific amount, such as a standard rebate. Checks written by individuals and businesses do not have an amount field encoded in magnetic ink until the check is initially processed upon receipt at the bank of first deposit, whereupon the amount is often printed on the check by a separate document processor, although it is not required in most cases. There are up to 10 character positions in the amount field 120 (if it is used) as defined by the ABA standard.

A process control field or transaction code field 122 is the next MICR character field on the check. The transaction code field is used to indicate the type of processing the item should have, indicating whether it is a check, stop payment, deposit, or other financial document with an alternate meaning that requires a corresponding alternate process. There are up to six digit positions in the process control field.

An account field 124 is the next MICR character field on the check. It is almost universally put on the check, since it includes characters indicating the account against which the check should be drawn. The account field has zero to fourteen MICR character (digit or dash symbol) positions under the ABA standard. Each bank may have millions of accounts. Account numbers are not standardized under the ABA standard. Banks are permitted to define their own internal rules for the creation of account numbers. Since the account number is written in MICR characters, and since the MICR character set does not include letters, the characters in the account number field are limited to the digits 0-9 and the dash character, and account numbers themselves are limited to digits 0-9. In some cases, banks may create consecutive account numbers. In other cases, banks will create account numbers that can be verified using algorithms or test similar to the “modcheck test” described above. Thus, account numbers at certain banks may be amenable for MICR character error checking using the same technique described above for use with bank routing numbers. A bank can compare a MICR account number with errors with its list of known valid and issued account numbers and determine from that comparison what the missing characters of the account number are.

The next field is optional field 4 126. It is called “optional” since a bank can encode whatever data (or none at all) it wishes in this field. Generally, however, banks have encoded the check number in this field. There are zero to four digits in optional field 4 126 as defined by the ABA standard.

The bank routing number field 128 is the next field. The bank routing number, as described above, is a nine digit field as defined by the ABA standard. A special MICR character, shown herein for convenience as the pound (“#”) symbol, is disposed on either end of the bank routing number. This is also defined by the ABA standard, and serves to identify the beginning and the end of the bank routing number field 128. This assists the MICR reader in determining the beginning and the end of the field, and also assists the program that processes the bank routing number in identifying the start and the end of the bank routing number field. When this character is read by a MICR reader, it is typically represented as the hex character 0×0c. We do not show an actual image of the character in this patent application, since the character is unique to the MICR character set and not available in the standard text fonts used for patents. The special character itself appears as a rectangular vertical bar followed by two small squares disposed one above the other just to the right of the vertical bar.

The next field 130 is called “optional field 6”. Again, it is defined as optional under the ABA standard and thus a bank can use this field for any purpose. There are zero to two characters in optional field 6 130.

The final field defined by the ABA standard for use on checks is the serial number or alternate “on-us” field 132. There are zero to ten digits in the serial number field 132 defined by the ABA standard.

It should be noted that the check 118 shown in FIG. 2 is exemplary of a typical check, the sort the small-business or individual would use in handling their daily affairs. Check 118 has several other regions more familiar to the consumer, including a date region 134, a numeric or courtesy amount region 136, a recipient or payee region 138, and a written or legal amount region 140.

The date region 134 on the check is a location generally in the upper right hand corner where the author of the check writes the date the check was created. The numeric amount region 136 is generally located vertically midpoint in the check on the right hand side, typically in a special box or block 142. Numeric amount region 136 is where the author of the check writes the amount of the check as a series of digits. Recipient region 138 is where the author of the check writes the name of the person or entity who receives the check. Written amount region 140 is where the author of the check writes the amount as a series of alphabetic characters.

Referring back to FIG. 1, in addition to the MICR reader, document processor 102 further comprises an image scanner 144 that is disposed adjacent to the check flow path 114 and is configured to sense an optical image of each check as that check passes scanner 144, and to transmit that scanned image in digital form to controller 104 for further processing. Scanner 144 may be a line scanner or bar scanner that scans across the surface of the check as the check passes underneath and generates the image as a sequence of individual lines or bars of the check. Alternatively it may be a two-dimensional imager, such as a digital camera or other device capable of perceiving a large two-dimensional region of the check (typically the entire check) at once. Alternatively, scanner 144 may be comprised of several individual scanners, each of which being disposed to image a different two-dimensional region of the check. These different images may overlap. Alternatively, scanner 144 may include a combination of one or more two-dimensional imagers and one or more line or bar scanners. The scanner is responsive to visually perceivable frequencies of light, unlike the MICR reader, which is responsive to magnetic flux generated by the MICR characters written in magnetic ink.

Controller 104 is coupled to document processor 102 by a communications link 146. Controller 104 controls the operation of the document processor. In most configurations, the document processor 102 and controller 104 are manufactured and sold as single unit. See, for example, the 7700 series and the iTran series of document processors by NCR Corp (Dayton, Ohio); the E series and the X series image capture hardware by IBancTec (BancTec Corp., Irving, Tex.); the NDP series of document processors from Unisys (Unisys Corp., Minneapolis, Minn.); the 3890 series of document processors from IBM (IBM Corp., Armonk, N.Y.); and teller systems from ARGO (ARGO Data Resource Corp., Dallas, Tex.), among others.

Document processor 102 and controller 104 do not need to be manufactured and sold as a single unit, however. In fact, there are advantages to providing the document processor 102 with its mechanical paperhandling system separate from controller 104, indeed at a considerable distance from controller 104. Inputs and outputs to controller 104 include digital data and instructions. Inputs and outputs to document processor 102 include checks, and digital data and instructions.

It may be desirable to locate document processor 102 in a secure region of a bank or other institution where a flow of paper checks can be more easily controlled and monitored.

Controller 104 is preferably located in a climate controlled computer room or facility. Since the communication between document processor 102 and controller 104 comprises digital data and commands, digital communications link 146 can be as simple as the wiring coupling the MICR reader, image scanner, and transport mechanism inside a machine housing to a microcomputer (the controller) located inside the same machine housing. Again, this unitary construction is currently the most common. On the other hand, digital communications link 146 can be as complex as a telecommunications network extending from document processor 102 through a LAN or WAN to a computer facility elsewhere in the same (or a different) building, city, state, country, or continent where controller 104 is located, and may include transport over one or more proprietary or intra-corporate networks as well as one or more public digital networks such as the Internet.

Controller 104 is a digital computer specially configured primarily (1) to control the operation of document processor 102, and (2) to receive the data read by MICR reader 116 and scanner 144, and (3) to transmit that data to a storage device 148 or (4) to transmit that data to a check processing control system (CPCS) 150 for further processing.

Controller 104 includes at least one central processing circuit (“CPU”) 152, an input/output circuit (“I/O”) 154, a nonvolatile memory circuit (“ROM”) 156, a volatile memory circuit (“RAM”) 158, which further includes a subcircuit called input buffer 160.

The program or programs that configure the CPU 152 and controller 104 to perform the functions described herein are preferably stored in hardware or firmware, such as in the memory circuits described herein, or on rotating computer disk storage media such as storage 148, or other computer-readable media.

CPU 152 controls the operation of controller 104, and hence document processor 102 as well. CPU 152 is configured to execute digital instructions stored in ROM 156, RAM 158, or retrieved from storage device 148.

ROM 156 stores digital instructions as well as program parameters that generally do not change. ROM 156 provides digital instructions to CPU 152, which executes them to control the operation of the check processing system 100.

I/O circuit 154 controls communications to and from other devices, such as CPCS 150 and document processor 102, and is configured to receive data and commands from these devices, and to transmit data and commands to these devices.

RAM 158 provides working space for digital data and instructions that are generated and modified during the operation of controller 104. RAM 158 provides transitional storage space for data controller 104 receives from MICR reader 116 and scanner 144. A portion of RAM 158, called the input buffer 160, stores data that controller 104 reads from MICR reader 116. This data includes digital data corresponding to the MICR characters on each check. RAM 158 also includes a second buffer called the process buffer 161.

A data/control/communications bus 162 couples the CPU, ROM, I/O, and RAM together, permitting them to communicate at a high rate of speed

Controller 104 is coupled to storage device 148, which may include hard disk drives, CD-ROM drives or other digital electronic storage media. Controller 104 is also preferably coupled to a local operator terminal 164 from which the operator generates commands to controller 104 to operate document processor 102.

While controller 104 may, of course, be manufactured particularly for this application, it is preferably a standard personal or business computer (or computers) that is configured to run a standard operating system such as Windows XP, OS/2, or Linux. The main operating program on controller 104 is a transport control program 166 that monitors the functioning of the document processor 102 and controls its operation. Program 166 is typically stored on storage device 148 and is retrieved and placed in memory 156 for execution by CPU 152. Transport control program 166 includes the low level drivers that interface with the motors of the transport mechanism 108 and with the gates that open and close to provide access to the plurality of pockets 110 into which checks are sorted after they pass the MICR reader 116 and scanner 144. A preferred transport control program 166 is the IBM 3890/XP control program. This program has been emulated by most of the other manufacturers of document processors and controllers, and therefore the operation of the other transport control program 166 currently in the marketplace are quite similar to transport control program 166 described below.

Before describing the process performed by system 100 in detail, it is helpful to understand why it is being performed and how it fits into banking business methods. Banks receive checks from customers as deposits. Banks receiving checks from customers are called “banks of first deposit” (BOFD). At a minimum, these checks identify an amount of money, an account number from which that amount of money is to be drawn, and the bank holding that account and thus the bank responsible for providing the BOFD with the funds.

When the customer of the bank deposits the check in his account, the BOFD returns the check to the originating bank (the bank on which the check was drawn) and requests the amount of money. When the originating bank receives this check, it debits the account on which the check was drawn and tenders the money to the BOFD which then deposits it in the customers account. Banks may have to process many hundreds of thousands of checks per day. They are required to return the check and to credit the customer's account with the check amount in a very short period of time, typically on the order of 48 to 72 hours. In order to return these checks and get the money for their clients, they must sort the checks for return to each bank on which that check was drawn and then arrange for a courier to return the checks to that bank.

Sorting by hand would be too time-consuming. For that reason, banks use check processing systems such as the document processor 102 and controller 104 identified herein to take an unsorted collection of checks, sort them by bank, and package them for individual delivery to the appropriate bank. In order to sort them by bank, the identity of the bank must be determined from the bank routing number printed on the check. If the bank routing number cannot be determined, the check cannot be returned, and the bank of first deposit cannot credit the amount of the check to its customer's account.

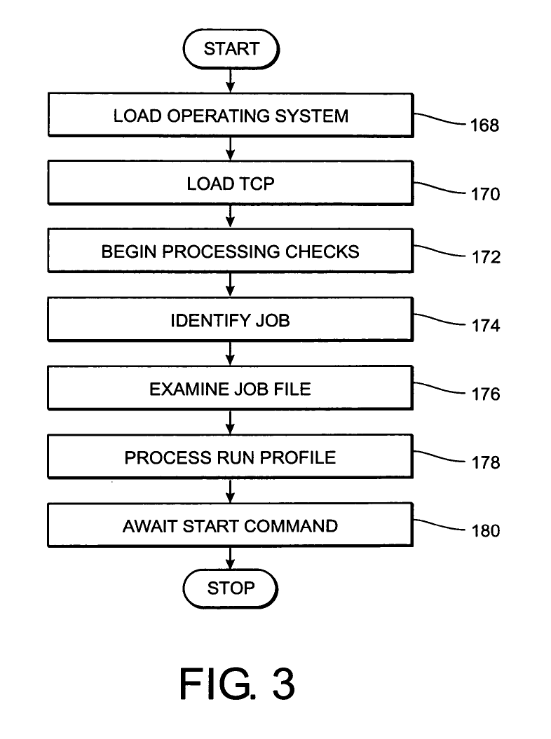

FIG. 3 illustrates a process of operating check processing system 100 from initial power up. In step 168, controller 104 loads the operating system. As explained above, this operating system is preferably Windows NT, OS/2, UNIX, or Linux. While other disk operating systems may also be used, these are preferred. In step 170, system 100 loads transport control program 166, which typically enters an idle state, waiting for operator input. In step 172, the operator (at terminal 164) commands controller 104 to begin processing checks.

The particular sorting process performed by system 100 on collection of checks 106 will depend upon how the bank has structured its business processes. The bank may wish to sort checks into several bins, each bin corresponding to a different bank or group of banks. In this manner, the bank may take all the checks from a given bin, package them, and transmit them via a courier service to the bank (or banks) identified by the routing numbers. Alternatively, it may wish to sort the checks into ranges of bank routing numbers, each range corresponding to a particular pocket in document processor 102, and then resort the contents of each of the pockets in several subsequent runs through the document processor 102 further subdividing each range of bank routing numbers until each pocket contains checks destined to be sent to only one bank. It is during any of these second or subsequent check sorting passes through the document processor that the code line data matching is performed, replacing the entire MICR line having one or more unreadable characters with a MICR line correctly read on a previous pass.

Whatever the business methods implemented by the bank having system 100, system 100 is flexible enough to permit any combination of rules, sorts, and error checking to be performed by a single machine. This ability to define several different check sorting processes and access each of those check sorting processes by name is possible given the configuration of controller 104.

In step 172, the operator requests a particular sorting process or “sort job” to be performed. This activates the document processor without having any documents loaded. The actual documents may be loaded in input hopper 112. They do not have to be loaded at this stage of the process, since the operator is merely preparing for the actual sort job that will be run.

Program 166 responds to this request in step 174 by identifying the sort job and accessing a text or binary file stored in a predetermined location. This file, called a “job file” herein, lists the particular parameters and instructions of the check sorting process to be performed. When the operator requests the sort job he wishes to be performed, program 166 opens this corresponding job file and loads the sorting process described therein into RAM 158. The job file is typically stored in storage device 148. The job file may alternatively be stored elsewhere in a different storage device. For example, controller 104 may retrieve this job file by accessing storage device 148 directly, or by sending up request for the job file over a local area network to another computer. In the preferred configuration, the operator can have several job files pre-designed and awaiting execution, depending upon the type of check sorting process to be performed, which in turn will depend upon the bank's internal business processes.

In step 176, transport control program 166 examines the job file to determine whether there is a particular run profile associated with that job file. A “run profile” is a text file indicating which additional programs transport control program 166 should run whenever certain events occur. These events, called “Sort Program Sequence [SPS] events” are generally triggered by changes in state of document processor 102, controller 104, or associated equipment, such as by the operator entering data at terminal 164. These events include an SPSINIT event, which occurs whenever the operator commands controller 104 to perform a particular sort job. They also include an SPSOPER event, which program 166 generates whenever the operator enters data at terminal 164 while a sort job is being performed. Program 166 generates an SPSVERIFY event whenever controller 104 fills the input buffer 160 with the characters read by MICR reader 116 from a check. Program 166 generates an SPSCORR event right after the SPSVERIFY event. Program 166 generates an SPSFORMAT event right after the SPSCORR event. Program 166 generates an SPSIMAT event right after the SPSFORMAT event. Program 166 generates an SPSDOC event right after the SPSIMAT event, and program 166 generates an SPSPOST event right after the SPSDOC event. Program 166 generates an SPSMS event whenever the motors of the document processor 102 stop.

Events SPSCORR through SPSPOST are triggered automatically when the additional programs identified in the run profile with the immediately previous event have completed their execution and return control to program 166. Events SPSVERIFY through SPSPOST are generated each and every time a check is processed. There may (or may not) be additional programs associated with each of these events that are executed.

The run profile associates the additional programs that are executed with the event that triggers their execution. The run profile also indicates the order in which these additional programs are executed. Each of the additional programs identified in the run profile and associated in the run profile with each event is typically a precompiled library of one or more functions. In a Windows or OS/2 environment, these additional programs are identified by their file extensions. They are called DLLs or “dynamic linking libraries”. They are libraries of individually executable procedures that are called (executed) by other programs and are stored as individual files in the memory or storage devices of a digital computer. DLLs are advantageous in that they can be upgraded by replacement of the DLL file itself, and do not require compilation with the program calling them. This is particularly beneficial in the

As mentioned above, program 166 examines the job file to determine if there is a run profile associated with that file. If there is, in step 178 program 166 opens the run profile text file, which is a text file including a list of the SPS events, the additional programs associated with each of those events, the order in which those additional programs are to be executed, and the format of the program calls to the functions in each of the additional programs. Program 166 then registers each of the additional programs. One of these additional programs listed in the run profile is configured to retrieve the contents of the input buffer and is called the “error correction program”. The error correction program is identified in the run profile as the first additional program to be executed when program 166 generates an SPSINIT, SPSVERIFY, SPSPOST, or SPSMS event. As part of the registration process for the error correction program, program 166 loads the error correction program into memory. The program 166 causes an SPSINIT event to be generated. The error correction program is executed and loads a file containing all valid and assigned bank routing numbers. This file is typically not embedded in or otherwise made a part of the error correction program. As a separate data file, it can be readily updated as new bank routing numbers are assigned without the operator having to recompile the error correction program itself to create a new DLL with the new list of bank routing numbers embedded therein. The error correction program is structured as a dynamic linking library, or DLL.

In step 180, program 166 finishes registering each of the additional programs identified in the run profile and waits for the operator to press a “start” button (not shown) coupled to controller 104 and begin executing the sort job. The operating system is loaded into RAM, the transport control program is loaded into RAM, the sorting instructions in the job file have been loaded into RAM, and the additional programs that are called whenever the transport control program generates an event are also loaded into RAM. In addition, the first program to be executed when the SPSVERIFY event occurs is loaded into RAM together with the list of assigned and valid bank routing numbers that it uses in order to process the MICR data read from each individual check.

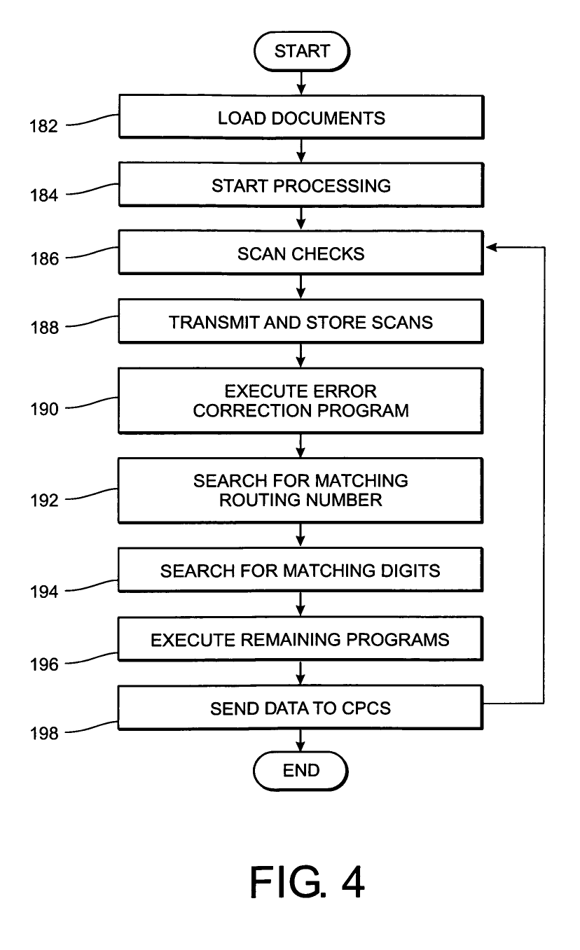

We refer now to FIG. 4, which illustrates how system 100 processes the checks to correct their routing numbers and, in particular, how controller 104 processes the MICR data it receives from controller 102.

In step 182, the operator loads the input hopper 112 of system 100 with a tray of many documents (e.g. checks) to be processed.

In step 184, the operator presses the start button coupled to controller 104 and controller 104 responsively begins to sort the checks. Controller 104 reads the instructions from the job file, which indicates the sorting and handling steps that are to be performed, and engages transport mechanism 108, which conveys checks one at a time down the flow path 114.

In step 186, as each check passes MICR reader 116, the reader scans the MICR characters on the check, converting them into a series of four bit values (nibbles) that the MICR reader pads to eight bits, leaving the four high-order bits zero. As each check passes scanner 144, it scans the check, creating one or more electronic images of the check and passes the image to controller 104.

MICR reader 116 includes internal logic configured to indicate any missing or unreadable characters by inserting special control characters into the data sent to the input buffer 160. These special characters are represented herein as asterisks (*). Thus, for each missing or unreadable character, MICR reader 116 substitutes a special control character in its place.

In step 188, MICR reader 116 transmits this stream of characters from processor 102 to controller 104, where the controller reads the characters and stores them in input buffer 160. The string of characters is the raw data received from MICR reader 116 with no formatting other than that provided by the MICR reader 116.

Controller 104 is configured by the transport control program to generate an SPSVERIFY event when the data is in the input buffer. When the system 100 was configured to execute this particular job (see FIG. 3), one of the tasks it performed was registering the various additional programs that can be run when different events occur. One of those additional programs that it registered was the error correction program for correcting unreadable bank routing numbers. So, when the data is placed in the input buffer, controller 104 then calls the error correction program it previously registered and hands off control of controller 104 to the appropriate routine in the error correction program. This routine was identified in the run profile, which also associated the error correction program with the SPSVERIFY event.

In step 190, the error correction program retrieves the routing number from the input buffer. To do this, the error correction program includes program steps that direct controller 104 to read the first characters in the input buffer. These characters include numbers that indicate the length of the input buffer. The error correction program then begins retrieving successive characters from the input buffer, and identifying them.

Part of the ABA standard that defines the proper format of MICR data on checks dictates that the bank routing number shall always be bracketed by two special characters. These characters are only used at the beginning and at the end of the bank routing number, and therefore indicate its beginning point and end point. Further, the standard for bank routing numbers also sets the length of the bank routing number at 9 digits. The error correction program checks each character in turn, until it reaches the first of these special characters. At this point the error correction program knows that it has reached the beginning of the bank routing number. The error correction program then copies each succeeding character into RAM memory locations until it reaches the second of the two special characters that delimit the bank routing number. As it reads each character of the bank routing number it determines which, if any of the bank routing number digits is missing—i.e. which if any of the bank routing number digits does not appear in the input buffer, but is replaced by the missing digit symbol (i.e. represented herein as an asterisk, *). At the end of this process, the error correction program controlling controller 104 will have extracted the entire routing number (plus special characters indicating the missing digits from the routing number) to RAM memory. If any of the bank routing number digits is missing or unreadable (as indicate by the special symbol generated by MICR reader 116 anywhere in the nine digits of the bank routing number read from the input buffer) controller 104 continues with the error correction programming step 190 below.

If there are no missing characters in the bank routing number, however, the error correction program exits and returns control to the transport control program. The transport control program then continues processing by executing the remaining additional programs in the run profile that are associated with the SPSVERIFY event and then by executing the programs associated in the profile with the other events. If the bank routing number has an error, however, controller 104 continues processing at step 192.

In step 192, controller 104, running the error correction program, searches the list of valid routing numbers for all routing numbers that match all the known good digits of the bank routing number.

Each digit in the bank routing number that the MICR scanner can accurately read and place in the input buffer is called a “good digit” herein. Its location in the scanned routing number is called a “good digit location” herein.

To do this, controller 104 determines the first good digit and the first good digit location. Controller 104 then selects the first valid routing number from the list of valid routing numbers. Controller 104 then compares the value of the first good digit with the value of the digit at the same location in the first listed valid routing number. If the two digits match, controller 104 then repeats the comparison process by comparing the second good digit in the scanned routing number at the second location with the corresponding digit at the same location in the first valid routing number from the list of valid routing numbers.

This process is repeated for each good digit in the scanned routing number until all the good digits in the scanned bank routing number match the digits in corresponding locations in the first valid bank routing number from the list of valid bank routing numbers.

Once controller 104 makes such a complete match between the known good digits, it saves a copy of the first bank routing number from the list of valid bank routing numbers in an array in RAM. Controller 104 then continues its comparison of the good digits in the scanned bank routing number with the corresponding digits in the next bank routing number of the list of valid routing numbers.

On the other hand, controller 104 may compare a good digit with the corresponding digit of the first bank routing number and the two will not match in value. Whenever this mismatch occurs, controller 104 “knows” that the first bank routing number cannot be the same as the actual bank routing number on the check that was scanned, and it aborts the comparison process and ceases comparing the first bank routing number with the good digits of the scanned bank routing number. Instead, it increments a counter and begins this digit-by-digit comparison process with the next (i.e. the second) valid bank routing number from the list of valid bank routing numbers.

In this manner the process is repeated until controller 104 has compared every valid bank routing number from the list of valid bank routing numbers with the scanned bank routing number, and has created an array of all the valid bank routing numbers that have digits with the identical locations and the identical values as all the known good digits of the scanned bank routing number.

In step 194, controller 104 examines each of the matching routing numbers it placed in the array of matching routing numbers (in step 192) to see whether a single digit can be found for each digit position. To do this, controller 104 determines the position of the first unreadable number in the scanned bank routing number. Again, the unreadable numbers are represented in the input buffer data by a special character represented herein as an asterisk. For example, if the first unreadable digit is the located in the third digit position in the bank routing number, controller 104 successively reads the third digit of each bank routing number in the array of valid bank routing numbers created in step 192 and compares them to determine if they all have a common value. If they do all have the common value, then the only possible value for the third digit in the scanned bank routing number is the common value. If controller 104 finds the common value, it then writes that common value into the input buffer, overwriting the special character (indicating unreadability) in the third digit position of the bank routing number.

On the other hand, if the comparison of values of the digits in the third digit position of the numbers in the array show that there are two or more values (i.e. no one common value) then controller 104 cannot conclude which of those values is the correct one and does not make any changes to the third digit of the bank routing number in the input buffer 160.

Whether it rewrites the third digit or not, controller 104 proceeds to similarly check all the other unreadable digits in the scanned bank routing number in the same manner, replacing the special “unreadability” character wherever possible. Note that in the above example I used the third digit location merely for convenience of explanation. Controller 104 compares the values at each digit location where there is an unreadable character in the bank routing number.

By the end of step 194, controller 104 has replaced the unreadable characters from the scanned bank routing number for one particular check wherever possible with the correct digit. And it determines what the correct digit is by determining whether or not there is one and only one possible digit that can be placed in that digit location and form a valid bank routing number. Whenever two or more digits can be placed in that location and still or a valid bank routing number, that digit is not corrected, but is left alone, with a character in the input buffer still indicating that that digit is unreadable.

Once each digit that can be corrected by comparison with the list of valid bank routing numbers has been corrected in the input buffer, the error correction program terminates and control is returned to the transport control program in step 196 in which the transport control program executes the remaining programs associated with the SPSVERIFY, SPSCORR, SPSFORMAT, SPSIMAT, SPSDOC and SPSPOST events are executed. The transport control program then transfers program control to the next additional program identified in the SPSVERIFY portion of the profile that was previously registered (FIG. 3). When this next program (if it exists) terminates and returns control to the transport control program, the transport control program repeats the process and transfers control to the next program in line, until all the programs listed for the SPSVERIFY event are complete.

Controller 104 is also configured to perform its own operations when the SPSVERIFY even occurs. In particular, transport control program 166 parses all the data in the input buffer, identifies the beginning of each of the MICR fields in the input buffer and assigns a unique pointer to each of the fields, including assigning a pointer to the now-corrected bank routing number field. This is done after the error correction process described above.

Once the programs associated with the SPSVERIFY event are complete, the transport control program then issues the SPSCORR event and sequentially calls each of the programs listed for that event in the same manner. The transport control program also executes its own programs that may do symbol error correction of the MICR data, and may correct leading zero errors in the amount field (if there is an amount field).

Once the programs associated with the SPSCORR event are complete, the transport control program then issues the SPSFORMAT event and sequentially calls each of the programs listed for that event in the same manner. The transport control program also executes its own programs that copy the input buffer, including the now-corrected bank routing number to a second buffer called the process buffer 161. The transport control program 166 also sets error flags for each field that is in error, either due to unreadable characters (digit error flag) or having an erroneous MICR field length (length error flag), among others.

By correcting the contents of the input buffer before these error flags are set, the system makes itself compatible with custom error handling procedures in existing software written by third parties that make use of the error flags. If the bank routing number were not corrected before the transport control program set the unreadable character error flag due to unreadable characters in the bank routing number, then the error flag could trigger unnecessary unique error handling routines responsive to the error flags that individual users of the system might have already written.

If these custom error handling procedures included such things as ejecting the check and sorting it to a particular pocket in the transport mechanism 108 for special processing (which is quite possible), then one major purpose for performing the routing number error correction—keeping as many checks together as possible and avoiding special manual processing—would be frustrated. These error handling routines would have to be rewritten to check for a corrected bank routing number instead of merely examining the error flag.

Once the programs associated with the SPSFORMAT event are complete, the transport control program then issues the SPSIMAT event and sequentially calls each of the programs listed for that event in the same manner. The transport control program also executes its own programs that do error correction of the MICR data when the SPSIMAT event occurs: code line matching (see above).

In code line matching, transport control program 166 examines the MICR data in the process buffer 161 and checks to see if any MICR field has erroneous (e.g. unreadable) data. If it does have erroneous (e.g. unreadable) data, the transport control program compares that erroneous field with a list of entire MICR lines read in a previous sorting pass through the system 100 and replaces the entire MICR line with a previously read 100% readable MICR line of the same check.

Once the programs associated with the SPSIMAT event are complete, the transport control program then issues the SPSDOC event and sequentially calls each of the programs listed for that event in the same manner. The SPSDOC event is typically where individual operators of system 100 will place their custom additional programs for validating the MICR data on checks and for routing those checks to particular pockets of the plurality of pockets 110 based upon that validation.

Once the programs associated with the SPSDOC event are complete, the transport control program then issues the SPSPOST event and sequentially calls each of the programs listed for that event in the same manner. In the SPSPOST event, the transport control program signals an appropriate pocket of the plurality of pockets 110 to open and receive the check whose data was scanned and placed in the input buffer. The transport control program 166 determines the proper pocket to open based upon operator programming in the job file, the associated profile, and the operator's custom additional programs.

In step 198, the transport control program transports the corrected MICR data associated with the just-scanned check to CPCS 150. CPCS 150 is preferably an IBM mainframe configured with the IBM's CPCS software (IBM Corp., Armonk, N.Y.), but may comprise other check processing applications such as Vector 3000 from Vector sgi (Vector sgi, Addison, Tex.) and IPS from Unisys (Minneapolis, Minn.). Indeed, the document processor need not be coupled to CPCS 150 at all. CPCS 150 is configured to receive the corrected MICR data for each check sorted by system 100. It is further configured to provide a detailed listing of the contents of each document (e.g. each check) in each of the pockets of document processor 102 into which the transport control program has sorted each check. CPCS 150 is configured to print this list out for the operator of system 100. The operator, in turn, wraps each list around its bundle of checks in the associated pocket and secures them together. The bank then returns the bundles of checks to the bank on whose accounts the checks were drawn (i.e. the bank identified by the bank routing number on the checks.

CPCS 150 is also configured to create cash letters. Each cash letter identifies each bundle of the bundles of checks processed for a bank together with the sum of all the amounts of the checks in those bundles. Thus the originating bank—the bank on which the checks were drawn—knows the total amount of checks received by the bank of first deposit and hence how much the bank of first deposit (i.e. the bank processing the checks in the description above) expects to receive in exchange for those checks.. These cash letters are then transmitted to the bank or banks identified by the bank routing numbers on the checks in the bundles identified in the cash letter. The cash letters are transmitted to their respective banks electronically or by courier.

Steps 186-198 in FIG. 4 describe the steps performed by controller 104 in processing a single check. These steps are repeated for each check placed in the input hopper 112 until the input hopper is empty, at which point the transport control program 166 is configured to automatically shut down transport mechanism 108, to generate the SPSMS event, executing any associated programs to the SPSMS event, and to await further instructions from the operator.

In the example above, the controller 104 is configured to correct bank routing numbers. In an alternative embodiment, controller 104 is configured to similarly correct any of the other fields in the MICR data. In some cases, financial documents that are sorted by system 100 may have a limited number of predetermined amounts that are printed on them in MICR characters, such as rebate checks, for example, that are only manufactured in certain predetermined denominations. In another alternative embodiment, system 100 may sort financial documents (for example checks) that include a MICR account number, and correct erroneous account numbers using the same process described above, except the list of valid numbers against which an unreadable account number would be checked would be a list of valid account numbers, and not bank routing numbers. In yet another embodiment, controller 104 is configured to correct numbers in any two or more MICR fields, for example, correcting the bank routing number and one of the optional fields or the amount field, or the amount field or the account number field as well. In these cases, steps 190 and 192 will be repeated for each of the other fields to be corrected, by extracting those fields from the input buffer and comparing them with a list of numbers valid for those fields in precisely the same manner as the bank routing number is corrected in steps 190-192 above.

From the above, it can be seen that a system for correcting MICR data on financial documents may comprise a document processor operable to retrieve MICR data from a plurality of financial documents; and a controller configured to receive said retrieved MICR data from said document processor; wherein the controller is programmed to perform data correction functions on the received MICR data.

The MICR data for each document may comprise a bank routing number, and the data correction functions include the function of correcting erroneous bank routing numbers.

The controller may be configured to correct erroneous bank routing numbers by comparing an erroneous bank routing number with correct bank routing numbers.

The controller may be configured to compare the erroneous bank routing number with a plurality of correct bank routing numbers.

The erroneous bank routing number may have a first plurality of known correct characters and at least one known incorrect character. The controller may be configured to determine all the correct bank routing numbers that have the same first plurality of correct characters as the erroneous bank routing number.

The controller may be configured to replace the erroneous bank routing number with the determined correct bank routing numbers if there is only one such determined correct bank routing number from the universe of correct bank routing numbers.

The controller may be configured to correct the bank routing number by replacing it with the determined correct bank routing number in an input buffer of the controller.

The document processor may be electrically coupled to the controller to receive the MICR data directly from the document processor as electronic signals.

The controller may be configured to also correct at least one additional data field in the input buffer in addition to the bank routing number by replacing erroneous or undetermined data in that additional data field with correct data.

The received MICR data may comprise a data field that is different from the bank routing number, and further wherein the controller is configured to correct the data in that different data field in the same manner as described in the preceding claims for correcting the erroneous bank routing number.

The bank routing number may be a MICR encoded account number, a MICR encoded amount number or a MICR encoded check number.

The programs that configure the controller to perform the data corrections functions may be stored in hardware or firmware, or on rotating computer disk storage media, and may include RAM and ROM memory or other computer-readable media.

Also disclosed is any computer readable media having written thereon at least part of the programs capable of configuring the controller to perform any of the data correction functions described herein.

### Image Processing System with Error Correction

In the section above, we explained how a document processor combined with a controller could read the MICR characters on a check, and correct unreadable characters by comparing the readable MICR characters with a list of known good characters. Even after this error correction, it may not be possible to determine the identity of all the unreadable characters.

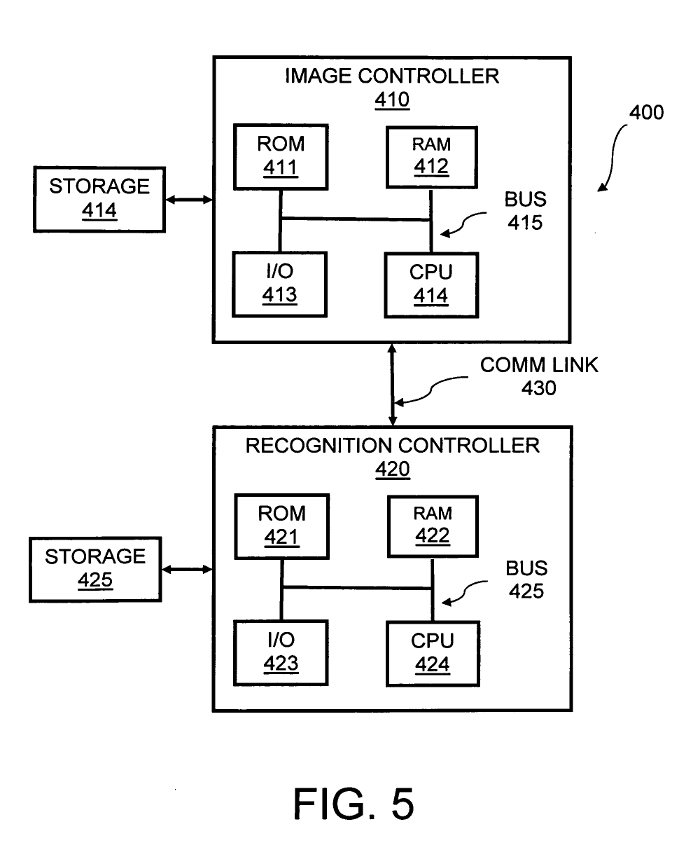

FIG. 5 is a block diagram illustrating a system 400 for processing documents in accordance with the second embodiment of the present invention.

The system 400 comprises an image controller 410, a communications link 430, and a recognition controller 420. The image controller 410 is operable to retrieve a document image from storage 414 and transmit the image and other data to the recognition controller 420 via the communications link 430. The recognition controller 420 is configured to receive a document image and other data from the communications link 430. The recognition controller 420 is operable to transmit the corrected routing number on the communications link 430 to the image controller 410 or other controllers, such as a data entry controller, coupled to the communications link 430.

Alternatively, the recognition controller 420 transmits the corrected routing number to storage 425 and/or the communications link 430.

Alternatively, the recognition controller 420 transmits the routing number and other data to a data correction controller configured to perform the data correction function.

Alternatively, the data correction controller can transmit the corrected routing number or list of possible valid routing numbers to the recognition controller 420, or other controllers, such as a data entry controller.

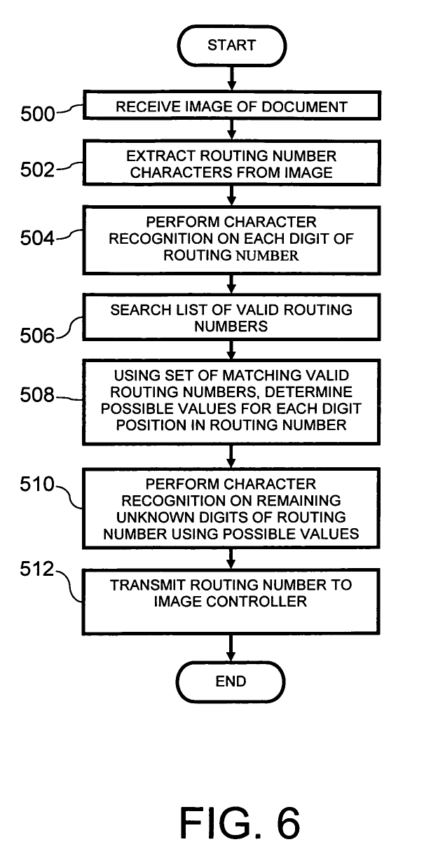

FIG. 6 is a flow diagram illustrating the process performed by the embodiment illustrated in FIG. 5.

The method begins at step 500 where the recognition controller 420 receives the document image. At step 502, the recognition controller 420 extracts the characters from the routing number of the document image. At step 504, the recognition controller 420 attempts to determine the value of each character extracted from the document image. At step 506, the recognition controller 420 performs the data correction function. The data correction function incorporates logic that searches a list of valid routing numbers for matches. The data correction function provides the set of matching valid routing numbers to the recognition controller 420. At step 508, the recognition controller 420 determines the set of valid digits for each character position of the routing number. At step 510, the recognition controller 420, using the set of valid digits as the only possible values, attempts to determine the digit value of each character position of the routing number that is still unknown. At step 512, the recognition controller 420 transmits the results of the character recognition function to the image controller, or other controller via the communications link 430 and the method comes to an end.

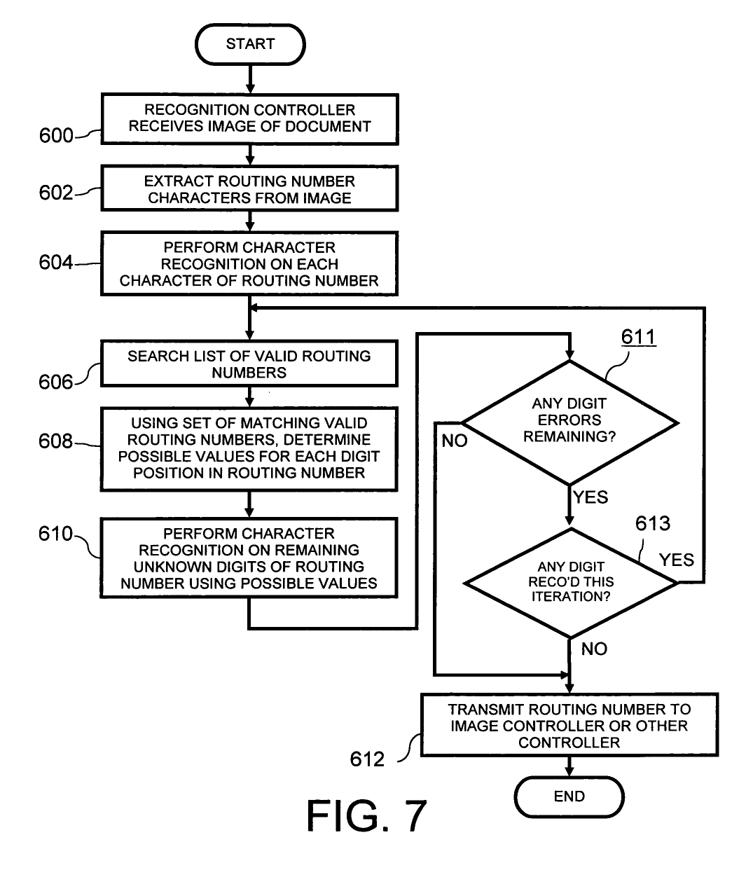

FIG. 7 is a flow diagram illustrating an alternative process performed by the embodiment illustrated in FIG. 5.

The method begins at step 600 where the recognition controller 420 receives the document image. At step 602, the recognition controller 420 extracts the characters from the routing number of the document image. At step 604, the recognition controller 420 attempts to determine the value of each character extracted from the document image. At step 606, the recognition controller 420 performs the data correction function. The data correction function incorporates logic that searches a list of valid routing numbers for matches. The data correction function provides the set of matching valid routing numbers to the recognition controller 420. At step 608, the recognition controller 420 determines the set of valid digits for each character position of the routing number. At step 610, the recognition controller 420, using the set of valid digits as the only possible values, attempts to determine the digit value of each character position of the routing number that is still unknown. At decisional step 611, a determination is made regarding whether any unknown characters remain in the routing number. If more digit errors remain, the method follows the Yes branch to decisional step 613. However, if no digit errors remain, the method follows the No branch to step 612. At decisional step 613, a determination is made regarding whether the value in any character position is successfully determined on the present iteration of the loop beginning with step 606 and ending with decisional step 613. If a character value is determined in the present iteration of the loop, the method follows the Yes branch to step 606. However, if no character value is determined in the present iteration of the loop, the method follows the No branch to step 612. At step 612, the recognition controller 420 transmits the results of the character recognition function to the image controller, or other controller via the communications link 430 and the method comes to an end.

It can be seen from the foregoing that a system for improving character recognition of fields such as routing number fields visible on an image of a financial instrument such as a check, comprises an electronic image controller configured to transmit the image of a check; and an electronic recognition controller configured to receive the image of a check and to perform character recognition functions on that image.

The image controller and the recognition controller may be coupled together by an electronic communications link that configured to transmit the image of the check from the image controller to the recognition controller.

A program stored in a RAM memory of the recognition controller may configure the recognition controller to perform the character recognition functions. The character recognition functions may include the function of determining a bank routing number by examining the image of the check.

The recognition controller may be configured to perform data correction functions at least when it cannot determine all the characters in the bank routing number as part of its character recognition functions.

The data correction functions may include computer logic in the recognition controller that receives the bank routing number including data indicative of undetermined characters in that routing number, and determining all the correct bank routing numbers that match the recognized characters of the bank routing number having undetermined characters.

The data correction functions may include providing the character recognition functions with a set of bank routing numbers that match the recognized characters of the bank routing number with undetermined characters.

The data correction function may be configured to search a collection of all valid, assigned, and active bank routing numbers and to return a set of all such bank routing numbers that match each known character in the bank routing number with undetermined characters.

The undetermined characters may have zero, one, two three, four, five, six, or seven undetermined characters.

The data correction function may be configured to return a plurality of matching bank routing numbers.

The data correction function may be configured to return bank routing numbers only in the form of a list of possible correct replacements for each undetermined character in the bank routing number with undetermined characters.

The set of all bank routing numbers returned by the data correction function may include at least one valid bank routing number where each known character in at least one valid bank routing number matches a character in the corresponding position of each valid bank routing number in the set.

The character recognition functions may be configured to re-recognize the undetermined characters based upon data received from the data correction functions.

The character recognition functions may be configured to receive the set of all such routing numbers, to revise its image recognition algorithm based on the set, and then to re-recognize the undetermined characters in the bank routing number based upon the reduced number of possible characters for each undetermined character position in the bank routing number with undetermined characters that were returned by the data correction function.

The check may be another type of financial document. The check may be a money order or a draft. The recognition controller may be configured to perform the data recognition functions of the account number field of the financial document.

The data correction function may be configured to search an electronic collection of valid account numbers and to return a list of valid account numbers to the character recognition functions.

The electronic collection may include all account numbers issued by at least one institution.

The electronic collection may include a predefined subset of all account numbers issued by at least one institution.

The electronic collection may include a list of all account numbers required by cycle sort and statement sort work types processed on document processors.

The data correction functions may include the function of loading account lists from a plurality of financial institutions.

The recognition controller may be configured to perform any of the data correction functions on any other field displayed in the image of the check or other financial document.

The recognition controller is configured to perform any of the data correction functions described above on the account number field, the check number field and the amount field in the image of the check or other financial document.

The logic incorporated in the data correction function may be encoded in hardware, firmware, instructions stored in ROM, RAM or other suitable computer-readable media, including rotating disk media.

A computer readable media may store a digital computer program or programs configured to program the electronic image controller to perform the functions described herein.

A computer readable media may store a digital computer program configured to program the electronic recognition controller to perform its functions that are described in any of the claims 17-42 recited herein.

A computer readable media may store a digital computer program configured to program the document processor to perform its functions that are described above.

The electronic image controller and the electronic recognition controller may be the same controller.

### Error Correction over a Network such as the Internet

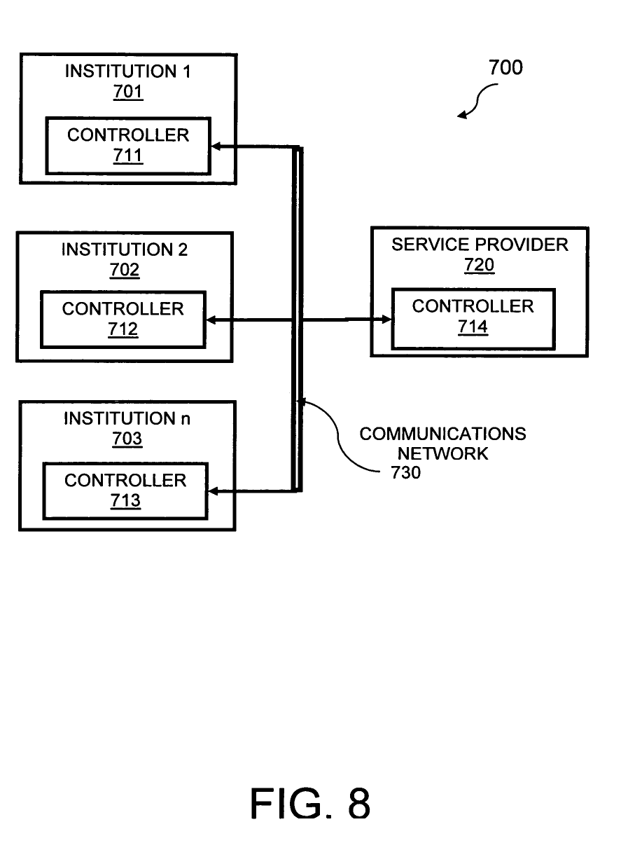

FIG. 8 is a block diagram illustrating a system 700 for processing documents. This FIGURE illustrates a system and method to receive data comprised of a routing number and other information, and transmitting a list of matching valid routing numbers and other information to a financial institution. The system includes a controller configured to receive the routing number, perform data correction functions, and transmit the matching valid routing number or numbers to a financial institution.

The data is transmitted across a public or private communication link between one of plurality of data correction controllers and one of a plurality of recognition controllers located in different geographic locations and operated by the same or different institutions. For example, the data correction function may be implemented as a web service on the internet available to multiple institutions simultaneously. Alternatively, the data correction function is performed by a data correction controller or a plurality of data correction controllers.

The system 700 comprises an institution 701 directing the operation of a controller 711, an institution 702 directing the operation of a controller 712, an institution 703 directing the operation of a controller 713, a service provider 720 directing the operation of a controller 714, and a communications network 730.

The controller 714 is configured to receive data incorporating a routing number and other information via the communications network 730. The controllers 711, 712, and 713 are configured to transmit the data to the controller 714.

The controller 714 is configured to transmit data incorporating the corrected routing number, list of valid routing numbers, list of characters for valid for a position within the routing number, and/or other information via the communications network 730.

Each of the controllers 711, 712, 713, and 714 may be located in different geographical locations. The institutions 701, 702, 703 may be the same institution or one of a plurality of different institutions.

It can be seen from the foregoing that a computer-implemented method for processing bank routing numbers is provided, comprising the steps of receiving data comprising at least a bank routing number; correcting at least the bank routing number; and transmitting at least the corrected bank routing number to a financial institution.

The method may comprise the step of matching the bank routing number with a valid bank routing number, wherein the corrected bank routing number is the matched valid bank routing number.

The steps may be performed by one or more data correction controllers.

The method may comprise the step of transmitting the corrected bank routing number across a public or private communications link.

The method may comprise the step of transmitting the corrected bank routing number across a public or private communications link between one of a plurality of data correction controllers and one of a plurality of recognition controllers.

The method may comprise the step of transmitting the corrected bank routing number across a public or private communications link between one of a plurality of data correction controllers and one of a plurality of recognition controllers located in different geographic locations.

The method may comprise the step of transmitting the corrected bank routing number across a public or private communications link between one of a plurality of data correction controllers and one of a plurality of recognition controllers located in different geographic locations.

At least one of the steps of transmitting or receiving may be performed by a web service over the Internet, the service being available to several institutions simultaneously.

Any of the steps of receiving may include the step of receiving the data over a public or private communications link.

Any of the steps of receiving may include the step of receiving the data from an input device attached to the controller, including a mouse or a keyboard.

Any of the steps of transmitting may include the step of transmitting the matching or corrected bank routing number over a public or private communications link.

Any of the steps of transmitting may include the step of transmitting the matching or corrected bank routing number to a visual display, or other human perceivable output means coupled to the controller.

The controller may be configured to compute a set of possible values for a character position over a public or private communications link.

The controller may be configured to derive the set of possible values from the matching routing numbers.

### Optical Error Correction System with Human Operator Interaction

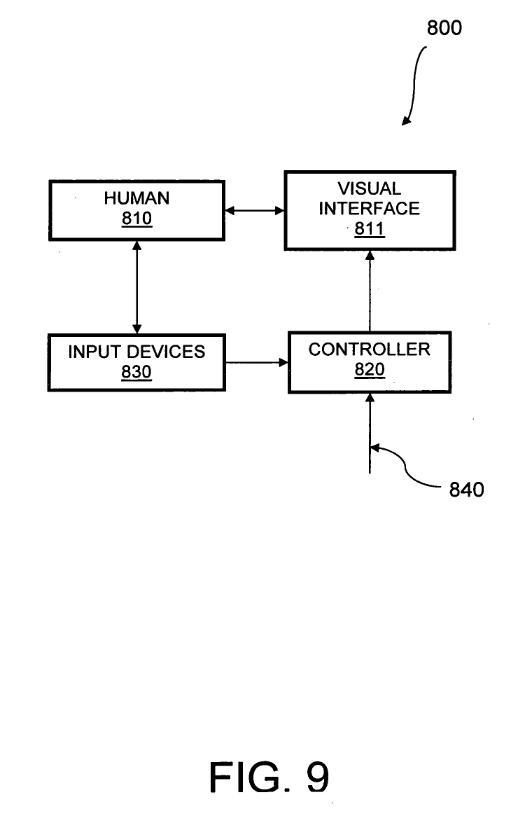

FIG. 9 is a block diagram illustrating a system 800 for processing documents.

The system 800 comprises a human 810, a controller 820, a plurality of input devices 830, and a visual interface 811 coupled. The controller 820 is coupled to the each of the plurality of input devices 830. The controller 820 is coupled to the visual interface 811. The controller is coupled to a communications link 840.

The controller 820 is configured to receive input from each of the plurality of input devices 830. The human 810 operates each of the plurality of input devices 830. The controller 820 is configured to transmit data, and other information to the visual interface 811. The visual interface 811 is configured to make visible the data, and other information received from the controller 820. The controller 820 is configured to receive, via the communications link 840, the results of a character recognition function performed on a document image.

A process for correcting routing numbers in accordance with the third aspect of the present invention illustrated in FIG. 8 follows.

The controller 820 receives, via the communications link 840, the routing number, and other data from a character recognition function performed on a document image. The controller 820 also receives a document image or portion thereof, and a list of valid routing numbers or other data from a data correction function performed on the routing number.

The controller 820 transmits the document image, the routing number, the valid routings numbers, and other data to the visual display 811 to affect their display to the human 810. The human 810 performs a data entry function using the input devices 830 to correct any undetermined characters in the routing number. The human 810 is assisted by having visible on the visual interface 811, the list of valid routing numbers. Alternatively, the controller 820 can affect the display of only set of possible characters valid for each position of the routing number prior to the human 810 entering the character. An example illustration, showing the data and information visible on the visual interface 811 is shown in FIG. 9. Using the input devices 830, the human 810 affects the controller 820 to store a digital electronic record of the corrected routing number and the process ends.

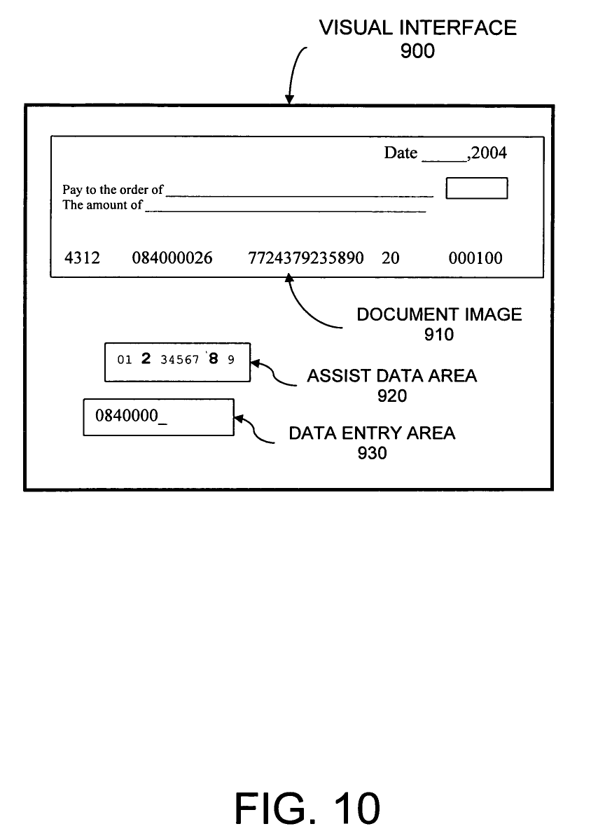

FIG. 10 is a block diagram illustrating an example visual display for the system 800 illustrated in FIG. 9 in accordance with the third aspect of the present invention.

The example visual display comprises a visual interface 900. The visual interface 900 is operable to make visible a document image 910, or portion thereof, assist data area 920, and a data entry area 930. A human 810 operates the system 800, illustrated in FIG. 9, to correct routing numbers. As the human 810, using the input devices 830, enters each character in the data entry area 930, the assist data area 920 is modified to show the valid characters for the current character being entered. Alternatively a list of valid routing numbers is displayed in the assist data area 920 as the human 810 enters data in the data entry area.

Although the present invention has been described in several embodiments, various changes and modifications may be suggested to one of ordinary skill in the art. It is intended that the present invention encompasses all such changes and modifications that fall within the scope of the claims.

For example, in the preferred embodiment the erroneous number (i.e. the number having one or more unreadable or otherwise unknown characters) is compared against all possible valid bank routing numbers the check can have. This is clearly the preferred method since it would find every error theoretically possible using the comparing technique described above. Not all valid numbers need be in the list for comparison, however, just substantially all of them. For example, bank routing numbers may be retired when banks merge. Patrons may still have checks or deposit slips in checkbooks with these retired numbers on them, and therefore a bank may continue to recognize them even though expired, since old checks with these expired numbers may still be used by some bank customers.

1. A computer-implemented system for correcting MICR data fields on financial documents, comprising:
a controller configured to receive MICR data from a document processor that is operable to retrieve MICR data from a plurality of financial documents;
wherein the controller is programmed to perform data correction functions on the MICR data, the data correction functions further comprising comparing an erroneous number in said MICR data with a plurality of correct numbers and electronically replacing the erroneous number with a number from said plurality of possible numbers.

2. The system of claim 1, wherein the MICR data includes a bank routing number, and further wherein the erroneous number is a bank routing number, and further wherein the plurality of possible numbers include a list of valid bank routing numbers.

3. The system of claim 1, wherein the erroneous number has a first plurality of known correct characters and at least one known incorrect character.

4. The system of claim 3, wherein the controller is configured to determine all correct numbers from the plurality of numbers that have the first plurality of correct characters.

5. The system of claim 4, wherein the controller is configured to replace all incorrect characters of the erroneous number with corresponding characters of the only one number when there is only one number of the determined correct number that was determined to be correct.

6. The system of claim 4, in which the controller is configured to replace a first character of said at least one known incorrect character in a first character position with a replacement character if all of the correct numbers have said replacement character in respective first character positions of all of said correct numbers.

7. The system of claim 5, wherein the controller is configured to correct the erroneous number by replacing all incorrect characters in a RAM buffer of the controller.

8. The system of claim 1, wherein the controller is operable to correct erroneous numbers from at least two MICR data fields on each of the plurality of financial documents by comparing an erroneous number in said MICR data in each of the at least two MICR data fields with a plurality of possible numbers for each of the at least two MICR data fields and by electronically replacing the erroneous number with a number from said plurality of possible numbers.

9. The system of claim 1, further comprising the document processor.

10. A computer-implemented method for correcting MICR data on financial documents, comprising the steps of:
electronically comparing an erroneous number in said MICR data with a plurality of possible numbers and electronically replacing the erroneous number with a number electronically selected from said plurality of possible numbers.

11. The method of claim 10, wherein the step of electronically comparing includes the step of electronically comparing an erroneous bank routing number in said MICR data with a list of valid bank routing numbers and electronically replacing the erroneous bank routing number with a bank routing number from said list of valid bank routing numbers.

12. The method of claim 10, wherein the erroneous number comprises a first plurality of known correct characters and at least one unrecognized character.

13. The method of claim 12, further comprising the step of determining all correct numbers from the plurality of possible numbers that have the first plurality of known correct characters.

14. The method of claim 13, further comprising the step of replacing all incorrect characters of the erroneous number with corresponding characters of the only one number when there is only one number of the determined correct number that was determined to be correct.

15. The method of claim 13, further comprising the step of replacing a first character of said at least one known incorrect character in a first character position with a replacement character if all of the correct numbers have said replacement character in respective first character positions of all of said correct numbers.

16. The method of claim 14, further comprising the step of replacing the erroneous number with the only one number that was determined to be correct in a RAM buffer of the controller.

17. The method of claim 10, wherein the step of electronically comparing comprises the steps of:
electronically comparing a first erroneous number in a first MICR data field with a first plurality of all possible numbers that the first erroneous number can be and still be valid; and
electronically replacing the first erroneous number with a number selected from the first plurality based at least upon the outcome of the step of electronically comparing.

18. A computer-implemented method for correcting a line of MICR data of a financial document having an unreadable character, comprising the steps of:
electronically scanning the line of MICR data using a MICR reader;
converting the line of MICR data into a first series of numbers and storing the first series in an input buffer;
identifying a first MICR field from the first series of numbers;
sequentially comparing a readable portion of the first MICR field with each successive member of a list of valid first field numbers to determine whether a unique member of the list of valid first field numbers matches the readable portion; and
replacing the first MICR field with the unique member or with portions of the unique member that correspond to an unreadable portion of the first field.

19. The method of claim 18, wherein the step of replacing the first MICR field includes the step of replacing the first MICR field in the input buffer with the unique member or with portions of the unique member that correspond to an unreadable portion of the first field.

20. The method of claim 18, further comprising the step of leaving at least one unreadable portion of the line of MICR data unchanged.
